(19) United States
(12) Patent Application Publication
(10) Pub. No.: US 2020/0160273 A1
(43) Pub. Date: May 21, 2020

(54) GEOLOCATION WEB PAGE GENERATION SYSTEM

(71) Applicant: ADP, LLC, Roseland, NJ (US)

(72) Inventors: Aravind Sundar, Bristol (GB); Jordan Beard, Bristol (GB); Matthew Lawson, Bristol (GB)

(21) Appl. No.: 16/193,324

(22) Filed: Nov. 16, 2018

(51) Int. Cl. G06Q 10/10; G06F 16/958; G06F 16/9537

(52) U.S. Cl. CPC G06Q 10/105; G06F 16/9537; G06F 16/958

(57) ABSTRACT

A method, computer system, and computer program product for digitally performing a human resources operation. A computer system interprets a plurality of linked metadata objects forming a syntax tree. The metadata objects defining what a web page looks like without content for the web page. The computer system identifies a geolocation context for the web page based on the plurality of linked metadata objects. The computer system interprets a geolocation object in the plurality of linked metadata objects. The geolocation object is interpreted within the identified geolocation context for the web page. The computer system then displays the geolocation object in the web page according to the identified geolocation context.

### BACKGROUND INFORMATION

### Field

The present disclosure relates generally to an improved computer system and, in particular, to a method and apparatus for generating pages. Still more particularly, the present disclosure relates to a method and apparatus for generating a web page for display on a browser.

### Background

The Internet is a global system of interconnected computer networks. The Internet is commonly used to access information resources and services. These information resources and services include documents and applications. In particular, the World Wide Web is an information system accessed via the Internet. This information system is a collection of documents that are linked to each other. These documents are called web pages.

The web pages may be accessed through an application called a web browser on a computer. This application facilitates retrieving, presenting, and traversing information using the web pages. A web page may include text, images, video, multimedia components, or other information. In addition, web page navigation components are in the form of hyperlinks which are often referred to as just links.

A web page may have fixed content and dynamic content. The fixed content may be particular areas in the web page. The dynamic content may be advertisements. In another example, the dynamic content may be information requested by the user. For example, a user may send a request to view banking transactions, current balances, order histories, and other information that may be specific to the user.

Currently, a user requests a web page by selecting a link on a current web page, entering a universal resource locator, or through some other action using a browser. The requested web page is typically generated by a web page server in a remote location and sent to the browser.

For example, the requested web page may be generated using hypertext markup language (HTML), cascading style sheets (CSS), and C # or Java code for the web page. The hypertext markup language may define static content for the web page. The cascading style sheets describe the look and formatting for the web page. The code may be used to generate dynamic content for the web page. The generation of the dynamic content may be performed using an ASP.net servlet located on the web page server. This dynamically generated web page is then returned to the browser.

The generation of the web pages uses resources on the web page server. For example, the web page server interprets the markup language, scripts, and other code for the web page to generate the web page that is sent to the browser for display. If the amount of traffic on a web page server is high enough, the generation of the web page and sending the web page to the browser may take more time than desired.

For example, a web page server for a popular website may have requests in the thousands per second or tens of thousands per second during high levels of traffic at the website. With this level of traffic, requests may be handled by multiple web page servers to avoid undesired levels of response times for web pages.

Additionally, a web page may have many different versions of a web page. Each version may be a separate web page for static web pages or content may be present for the different versions for a dynamic web page. The information for these different versions may use more storage space than desired in addition to the processing issues described above.

With the processing resources needed at web servers and the storage space needed for different versions of web pages, the resources needed to generate web pages may be more than available or more expensive than desired. Therefore, it would be desirable to have a method and apparatus that take into account at least some of the issues discussed above, as well as other possible issues. For example, it would be desirable to have a method and apparatus that overcome the technical problems of the large amounts of time and effort needed to provide different versions of web pages to perform operations and insufficient resources for web page servers being present to generate web pages sent to client data processing systems.

### SUMMARY

An embodiment of the present disclosure provides a method for digitally performing a human resources operation. A computer system interprets a plurality of linked metadata objects forming a syntax tree. The metadata objects defining what a web page looks like without content for the web page. The computer system identifies a geolocation context for the web page based on the plurality of linked metadata objects. The computer system interprets a geolocation object in the plurality of linked metadata objects. The geolocation object is interpreted within the identified geolocation context for the web page. The computer system then displays the geolocation object in the web page according to the identified geolocation context.

Another embodiment of the present disclosure provides a computer system comprising a hardware processor and a web page generator in communication with the hardware processor. The web page generator interprets a plurality of linked metadata objects forming a syntax tree. The metadata objects defining what a web page looks like without content for the web page. The web page generator identifies a geolocation context for the web page based on the plurality of linked metadata objects. The web page generator interprets a geolocation object in the plurality of linked metadata objects. The geolocation object is interpreted within the identified geolocation context for the web page. The web page generator then displays the geolocation object in the web page according to the identified geolocation context.

Yet another embodiment of the present disclosure provides computer program product for digitally performing a human resources operation, the computer program product comprising a non-transitory computer readable storage media and program code stored on the computer readable storage media. The program code includes code for interpreting a plurality of linked metadata objects forming a syntax tree. The metadata objects define what the web page looks like without content for the web page. The program code includes code for identifying a geolocation context for the web page based on the plurality of linked metadata objects. The program code includes code for interpreting a geolocation object in the plurality of linked metadata objects. The geolocation object is interpreted within the identified geolocation context for the web page. The program code includes code for displaying the geolocation object in the web page according to the identified geolocation context.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an application development system in accordance with an illustrative embodiment;

FIG. 2 is an illustration of a block diagram of an example of an operation of a user interface engine shown in FIG. 1 in accordance with an illustrative embodiment;

FIG. 3 is an illustration of a block diagram of an application development environment in accordance with an illustrative embodiment;

FIG. 4 is an illustration of a block diagram of metadata in accordance with an illustrative embodiment;

FIG. 5 is an illustration of a block diagram of a layout in accordance with an illustrative embodiment;

FIG. 6 is an illustration of a block diagram of objects in accordance with an illustrative embodiment;

FIG. 7 is an illustration of a block diagram of rules in accordance with an illustrative embodiment;

FIG. 8 is an illustration of a block diagram of a metadata tree structure in accordance with an illustrative embodiment;

FIG. 9 is an illustration of a block diagram of an architecture of a metadata-based human resources management system in accordance with an illustrative embodiment;

FIGS. 10A-10B are an illustration of a graphical user interface for designing a web page in accordance with an illustrative embodiment;

FIGS. 11A-11B are a second illustration of a graphical user interface for designing a web page in accordance with an illustrative embodiment;

FIGS. 12A-12B are a third illustration of a graphical user interface for designing a web page in accordance with an illustrative embodiment;

FIG. 13 is an illustration of a web page that displays geolocation objects in accordance with an illustrative embodiment;

FIG. 14 is an illustration of a web page that displays filtered geolocation features in accordance with an illustrative embodiment;

FIG. 15 is an illustration of a second web page that displays information for a selected filtered geolocation object in accordance with an illustrative embodiment;

FIG. 16 is an illustration of a third web page that displays information for a selected filtered geolocation object in accordance with an illustrative embodiment;

FIG. 17 is an illustration of a fourth web page that displays information for a selected filtered geolocation object in accordance with an illustrative embodiment;

FIG. 18 is a flowchart of a process for digitally performing a human resources operation in accordance with an illustrative embodiment; and

FIG. 19 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that currently used systems for designing web pages often do not allow a designer to focus on designing a web page as much as desired. The illustrative embodiments recognize and take into account that with currently used web page design systems, a designer often needs to have knowledge about markup languages, Web servers, or other technical areas.

Thus, the illustrative embodiments provide a method and apparatus for designing a web page. In one illustrative example, a method is presented for designing a web page. A computer system displays objects in a graphical user interface in a display system. The objects are selectable for use in designing the web page. The computer system generates metadata for the web page based on a user input selecting a group of the objects for the web page, wherein the metadata describes the web page. The computer system creates a preview of the web page from the metadata and displays the preview of the web page in the graphical user interface in the display system.

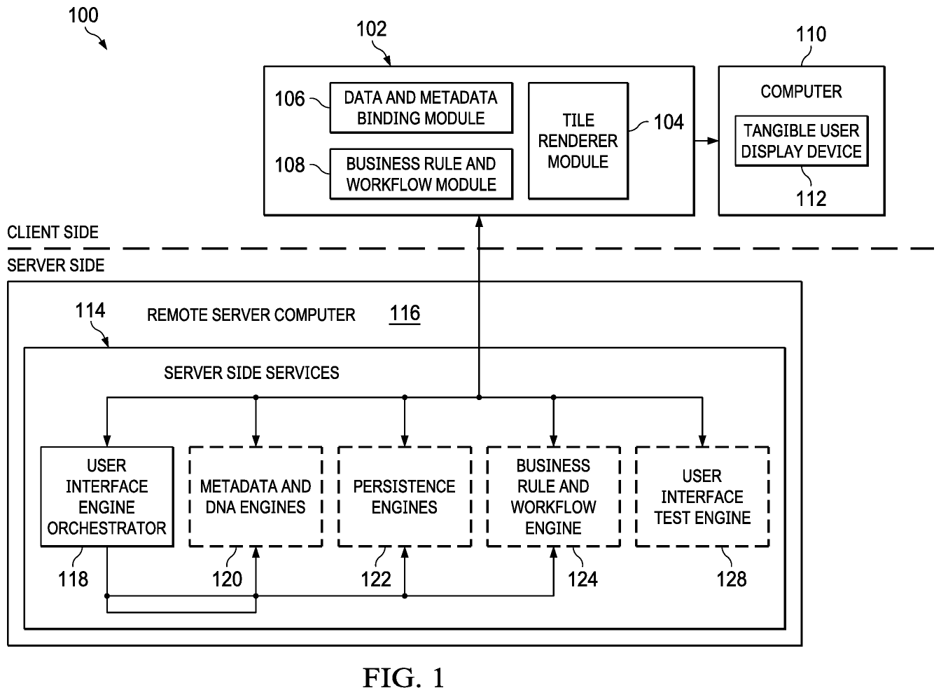

With reference now to the figures and, in particular, with reference to FIG. 1, an illustration of a block diagram of an application development system is depicted in accordance with an illustrative embodiment. Application development system 100 may be a development system that provides codeless development tools for combining distinct building blocks together to create, test, and use an application.

User interface engine 102 is computer code and underlying data and metadata which provides underlying functionality and implementation capability for the codeless development tools. From a software architecture viewpoint, user interface engine 102 is a client-side application, operating on a specific client user's computer. User interface engine 102 could be a Web browser or an extension to a Web browser, allowing for a user-friendly interface experience.

User interface engine 102 may be metadata driven. The metadata may describe a page and page layout of an overall web page without content. User interface engine 102 loads metadata for the page and then run queries against local or remote databases to get customer data used for constructing applications. User interface engine 102 may then perform interpretation of the metadata and retrieved data, presenting an interface customized for each user.

The metadata may take the form of a document object model (DOM) tree composed of JSON (JavaScript Object Notation) objects, though metadata may be composed of multiple data models. The document object model tree is a tree representation of an abstract syntactic structure of source code, independent of any particular representation or encoding. Each node of the tree denotes a construct occurring in the source code. As opposed to parse trees, typically built by a parser during a source code translation and compiling process, the document object model tree can be “abstract,” in that it is independent of any particular representation or encoding, and does not represent every detail appearing in the real syntax.

As depicted, user interface engine 102 may include three modules: tile renderer module 104, data and metadata binding module 106, and business rule and workflow module 108.

Tile renderer module 104 renders tiles on tangible user display device 112. Each tile represents a building block comprising a distinct, atomic unit of functionality executable by the computer. Tile renderer module 104 may receive input from the user, from data and metadata binding module 106, and from business rule and workflow module 108 to change and manipulate both the functionality of computer 110, which is used to execute tile renderer module 104, as well as tangible user display device 112, which is used to display rendered tiles.

Data and metadata binding module 106 binds data and metadata to the user interface, enabling user interface engine 102 to track the data and metadata used in executing business rules and rendering tiles.

Business rule and workflow module 108 enables creation of miniapps, collections, and bundles through the manipulation of tiles rendered by tile renderer module 104. Using data and metadata tracked by data and metadata binding module 106, business rule and workflow module 108 allows a user to develop software by manipulating tiles instead of writing code, thus enabling a codeless development environment from the perspective of the user.

In some illustrative embodiments, user interface engine 102 may take advantage of server side services 114 operating on remote server computer 116. “Server side” means that computer 110 communicates with remote server computer 116, possibly over a network such as the Internet. Server side resources are often provided to support and enhance the functionality of user interface engine 102.

Server side resources may include user interface engine orchestrator 118. User interface engine orchestrator 118 may serve as a proxy to speed up processing of user interface engine 102. User interface engine orchestrator 118 may retrieve metadata and resolve data queries from a data center operating server side. User interface engine orchestrator 118 may cache retrieved data, metadata, code, workflows, or objects to be sent back to user interface engine 102. In some cases, user interface engine orchestrator 118 may execute code server side and return the results to speed up processing by user interface engine 102.

Server side services 114 may include one or more components. Metadata and DNA engines 120 manage or provide metadata for use in user interface engine 102. One or more of persistence engines 122 are provided for saving work done using user interface engine 102. Business rule and workflow engine 124 may be used to create or store business rules and workflows that are used by user interface engine 102 in building applications. User interface test engine 128 may be used to test both the functionality of user interface engine 102, as well as the created applications.

The illustrative embodiments may be varied and are not necessarily limited by the examples described with respect to FIG. 1. For example, other server side resources could be provided, such as, for example, a database of pre-prepared commonly used miniapps, collections, or bundles. In another example, user interface engine 102 may include other modules, such as an interface module that allows user interface engine 102 to interface with other new or existing software installed on computer 110.

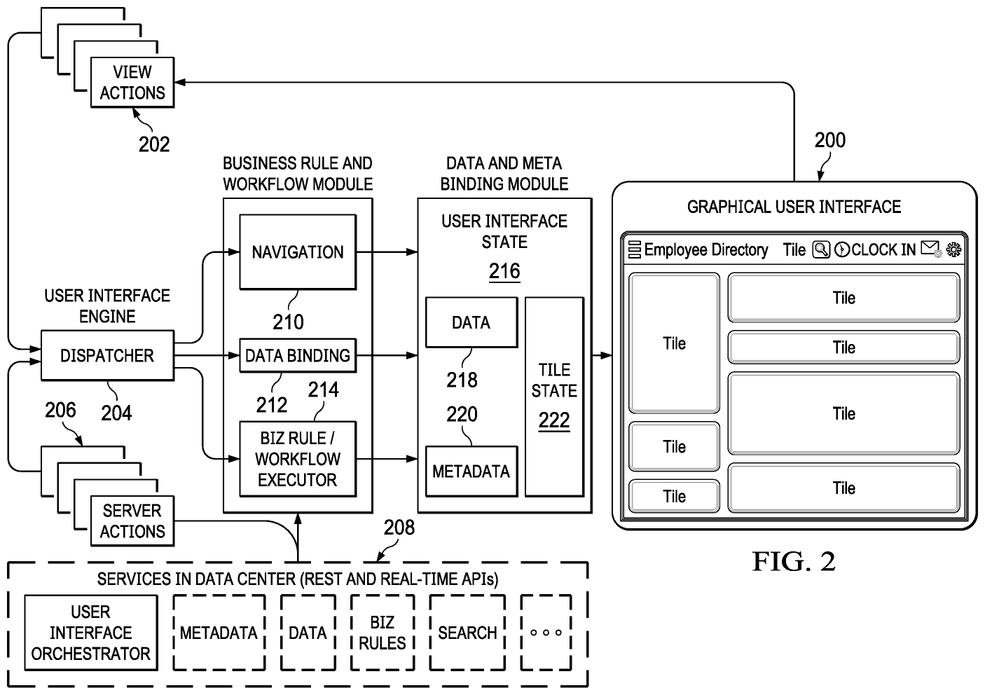

FIG. 2 is an illustration of a block diagram of an example of an operation of a user interface engine shown in FIG. 1, in accordance with an illustrative embodiment. The example shown in FIG. 2 does not necessarily limit operation of user interface engine 202 as shown in FIG. 1. Nevertheless, FIG. 2 may be read in conjunction with FIG. 1.

In an illustrative embodiment, tile renderer module 104 in FIG. 1 may be used to generate graphical user interface 200. Graphical ser interface 200 may take the form of tiles shown in a Web browser. Each tile may represent a building block. Alternatively, a tile may represent a miniapp, a collection, or even a bundle. Users may interact with graphical user interface 200, triggering, for example, a “view actions” command 202.

These actions are sent to dispatcher 204, which may be part of user interface engine 102, shown in FIG. 1. Dispatcher 204 may send the actions to the business rule and workflow module via subscriptions registered with dispatcher 204. Dispatcher 204 may also send server actions 206 sent by data center 208 to business rule and workflow module 108 in FIG. 1 for use in combination with the actions started by the user.

Business rule and workflow module 108 may run queries and apply business rules and other logic. Business rule and workflow module 108 may provide navigation 210, data binding 212, and execution by business rules and workflows executor 214.

Data and metadata binding module 106 may apply changes to user interface state 216 held in memory. User interface state 216 may be held in a tree structure containing data 218, metadata 220, and tile state 222. In turn, tile renderer module 104 in FIG. 1 may render graphical user interface 200. Tile renderer module 104 may listen to state changes in the tree structure and efficiently update only data 218 and metadata 220 that need re-rendering.

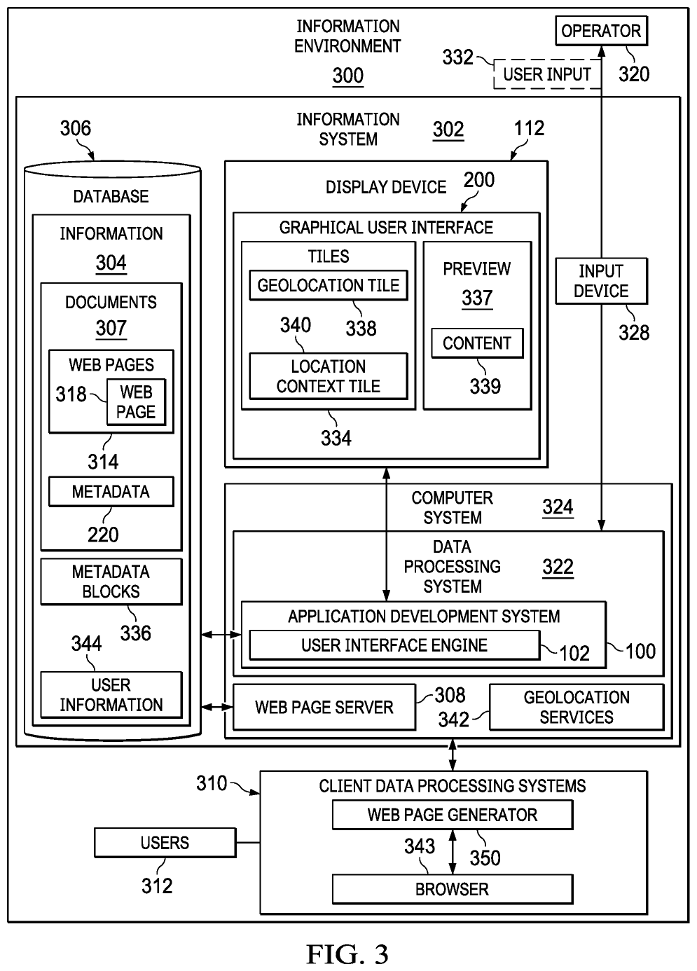

With reference now to FIG. 3, an illustration of a block diagram of an application development environment is depicted in accordance with an illustrative embodiment. In this illustrative example, information environment 300 includes information system 302. Information system 302 provides access to information 304 stored in database 306. As depicted, database 306 may be a storage system in a single location or may be distributed.

For example, web page server 308 sends information 304 to client data processing systems 310 operated by users. In this illustrative example, client data processing systems 310 are hardware systems that may include software. For example, client data processing systems 310 may be selected from at least one of a computer, a server computer, a workstation, a tablet computer, a laptop computer, a mobile phone, or some other suitable data processing system that may be used by users 312.

As used herein, the phrase “at least one of,” when used with a list of items, means different combinations of one or more of the listed items may be used and only one of each item in the list may be needed. In other words, “at least one of” means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In this illustrative example, a portion of information 304 takes the form of documents 307. As depicted, documents 307 may be web pages 314 that are displayed on client data processing systems 310. As depicted, web pages 314 are designed using application development system 100, including user interface engine 102. For example, web page 318 may be designed by operator 120 interacting with user interface engine 102.

In this illustrative example, user interface engine 102 may be implemented in software, hardware, firmware, or a combination thereof. When software is used, the operations performed by user interface engine 102 may be implemented in program code configured to run on hardware, such as a processor unit. When firmware is used, the operations performed by user interface engine 102 may be implemented in program code and data and stored in persistent memory to run on a processor unit. When hardware is employed, the hardware may include circuits that operate to perform the operations in user interface engine 102.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

As depicted, application development system 100 may be implemented in data processing system 322 within computer system 324. Computer system 324 is a hardware system that includes one or more data processing systems. When more than one data processing system is present, those data processing systems may be in communication with each other using a communications medium. The communications medium may be a network. The data processing systems may be selected from at least one of a computer, a server computer, a tablet, or some other suitable data processing system.

In the illustrative example, display device 112 and input device 328 are in communication with data processing system 322, and aid operator 320 in interacting with application development system 100.

Display device 112 is a hardware system and includes one or more display devices on which graphical user interface 130 may be displayed. The display devices may include at least one of a light-emitting diode display (LED), a liquid crystal display (LCD), an organic light-emitting diode display (OLED), or some other suitable device on which graphical user interface 130 can be displayed.

Operator 320 may interact with graphical user interface 200 through user input 332 generated by input device 328. Input device 328 may be, for example, a mouse, a keyboard, a trackball, a touchscreen, a stylus, or some other suitable type of input device.

In operation, user interface engine 102 in data processing system 322 displays tiles 334 in graphical user interface 200. As depicted, tiles 334 are selectable for use in designing web page 318.

In the illustrative example, tiles 334 represent distinct metadata blocks 336, which can be linked together to form metadata 220 for web page 318. By manipulating tiles 334, metadata blocks 336 can be linked together and interpreted by the computer to implement web page 318. Metadata blocks 336 may implement, or may be combined to implement, a graphical element, a business rule element, a script, a graphical control, or some other object that is used in web page 318. A business rule element is a functional element that performs some step, operation, or function. The functional element may not be visible. The functional element may be a script, a plug in, an extension, or some other suitable component.

User interface engine 102 generates metadata 220 for web page 318 based on user input 332 selecting a group of tiles 334 for web page 318. As used herein, “a group of,” when used with reference to items, means one or more items. For example, “a group of tiles 334” is one or more of tiles 334.

In generating metadata 220 for web page 318, application development system 100 does not generate hypertext markup language or cascading style sheets for web page 318. Application development system 100 does not generate markup language for web page 318 because web page 318 is described using metadata 220.

As depicted, tiles 334 include geolocation tile 338 and location context tile 340. Geolocation tile 338 corresponds to one or more of metadata blocks 336 that indicate that one or more of geolocation services 342 should be invoked to implement web page 318. Location context tile 340 corresponds to one or more of metadata blocks 336 that indicates a particular location context in which metadata blocks 336 of geolocation tile 338 should be interpreted.

In an illustrative example, a location context is based at least partially on a geolocation of an organization, employees of the organization, or users 312. As used herein, the term “geolocation” refers to the real-world geographic location of an object. A geolocation can include at least one of a set of geographic coordinates, or a meaningful location, such as a street address. Geolocations of organizations can be, for example, but not limited to, a corporate address, a place of business, a registered address, a corporate headquarters, a satellite office, and a retail location, as well as other suitable locations for the organizations.

Location context tile 340 for users 312 can be identified from user information 344. User information 344 is data about users 312. When users 312 are employees of organizations, user information 344 can be human resources data. Human resources data may include personal financial information for employees. For example, human resources data may include at least one of payroll information, tax information, salary information, a social security number, or other types of personal financial information of users 312. Human resources data can include personally identifying information about users 312. For example, user information 344 may include at least one of a social security number, a date of birth, a name, an address, a telephone number, a driver's license number, and a professional license number, as well as possibly other information that can be used to provide a location context.

In this illustrative example, metadata 220 describes web page 318. For example, metadata 220 may describe at least one of what information is to be displayed, how the information is to be displayed, and where the information is to be displayed in web page 318.

In the illustrative example, user interface engine 102 creates preview 337 of web page 318 from metadata 220 and content 339. As opposed to metadata 220 that describes how or what something looks like in web page 318, content 339 is data 218 of FIG. 2 that is to be expressed in web page 318. Content 339 may include at least one of text, images, video, audio, graphics, or other information that is put into web page 118.

Once web page 318 is completed, application development system 100 stores metadata 220 for web page 318 in database 306. Application development system 100 does not store markup language for web page 118 because web page 118 is described using metadata 220.

In the illustrative example, client data processing systems 310 may access and display web pages 114 by retrieving metadata 220 for web page 318. Client data processing systems 110 may obtain metadata 220 for web page 318 from web page server 308.

In this illustrative example, client data processing systems 310 display web page 118 in browser 343. Browser 343 is a program or application that includes web page generator 350. Web page generator 350 implements user interface engine 102, or a portion thereof, such as business rule and workflow module 108 of FIG. 1, that is configured to interpret metadata 220 received from web page server 308, to identify and retrieve content 339 from database 306, and to create and display web page 318 using metadata 220 and content 339.

In this illustrative example, web page generator 350 in browser 343 interprets metadata 220 within the location context of metadata blocks 336 indicated by geolocation tile 338 and location context tile 340. In this manner, metadata 220 indicated by geolocation tile 338, inclusive of its children, provides additional context for execution of related metadata blocks and for business rule output provided to a consuming service. Business rule output is already executable because they are generated from the pre-determined atomic units of code specified by the executor functions selected client-side. Thus, business rule output is provided directly to one or more of consuming service. By avoiding translation of metadata and compilation of executable code, the speed of both rule generation and rule execution is dramatically increased.

Information system 302 is a specific implementation of the illustrative embodiments. Thus, information system 302 does not necessarily limit the claimed inventions, or other business rule systems described herein.

The illustration of information environment 300 in FIG. 3 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in addition to storing metadata 220 for web pages 314, other web pages may be present in addition to or in place of web pages 314 that are described using markup languages such as hypertext markup language (HTML), extensible markup language (XML), or some other suitable type of markup language. These types of web pages, however, may require different versions for different types of browsers in order to have a desired consistency for how the web pages are displayed on client data processing systems 110.

As another illustrative example, metadata 220 for web page 318 may be obtained from other locations other than from web page server 308. For example, metadata 220 may be located in a local cache in a client data processing system, a proxy server, a data processing system that is remote to data processing system 322, or some other location. In this example, data processing system 322 is a first data processing system and the data processing system that is remote to data processing system 322 is a second data processing system.

As another example, content 339 may be located in other locations other than database 306. For example, content 339 may be obtained from another server other than web page server 308.

In other illustrative examples, a copy of content 339 may be stored locally on client data processing systems 310. In these other illustrative examples, accessing the copy of content 339 stored locally on client data processing systems 310 enables local creation of preview 337 with content 339 without accessing a server for content 339.

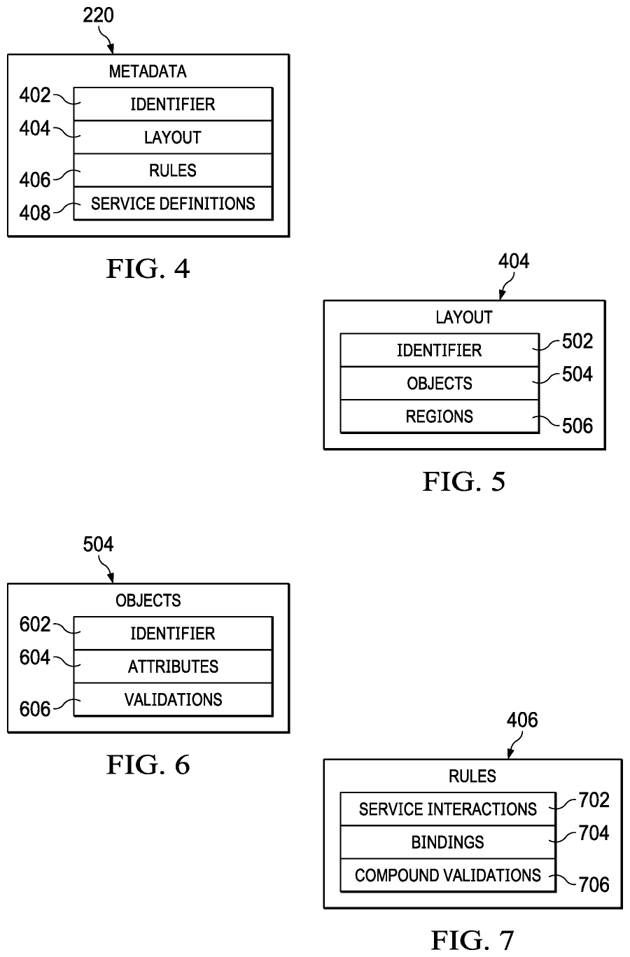

Turning to FIG. 4, an illustration of a block diagram of metadata is depicted in accordance with an illustrative embodiment. In this illustration, an example of a number of components of metadata 220 for web page 318 is shown.

As depicted, metadata 220 includes identifier 402, layout 404, rules 406, and service definitions 408. Identifier 402 points to web page 318. For example, identifier 402 may be a universal resource locator for web page 318. Layout 404 in metadata 220 is a layout for objects displayed on web page 318.

Rules 406 are included in metadata 220. In this illustrative example, rules 406 are at least one of code that performs actions for objects in layout 404, or options used by code to perform actions for objects in layout 404. For example, if the layout for web page 318 includes a button, a rule in rules 406 for the button may be to execute code that performs an action for the button when a user input selects the button.

In this illustrative example, when a rule in rules 406 for an object in layout 404 is located in metadata 220, the rule is an embedded rule for the object. In other words, the rule in rules 406 is embedded in metadata 220 for the object for web page 318 when the rule is included in metadata 220 for the object for web page 318.

Service definitions 408 is configuration information for sending and receiving user data and content. The configuration information in service definitions 408 includes at least one of JSON service definition configuration information, or other suitable types of service definition configuration information. For example, service definitions 408 may include information for using JSON objects through restful application programming interfaces to send and receive user data and content.

Turning next to FIG. 5, an illustration of a block diagram of a layout is depicted in accordance with an illustrative embodiment. In this illustration, an example of a number of components of layout 404 in metadata 220 for web page 318 is shown.

In this illustrative example, layout 404 includes identifier 502, objects 504, and regions 506. Identifier 502 is alphanumeric characters for layout 404 used to identify layout 404 in web page 318. Objects 504 are a group of objects to be displayed in web page 318. Regions 506 are portions of web page 318 where objects 504 are located relative to each other when web page 318 is displayed.

Turning now to FIG. 6, an illustration of a block diagram of objects is depicted in accordance with an illustrative embodiment. In this illustration, an example of a number of components of objects 504 in layout 404 in metadata 220 for web page 318 is shown.

As depicted in this example, objects 504 include identifiers 602, attributes 604, and validations 606. Identifiers 602 are names for objects 504. These names may be used to identify one object from another in objects 504.

Attributes 604 are values for objects 504 that define objects 504. Attributes 604 include at least one of display characteristics, content, default selections, or other suitable types of attributes for objects 504.

In this illustrative example, validations 606 are at least one of code that validates objects 504, or options used by code to validate objects 504. For example, when the object is a date, the validation code may verify that the date entered by an operator is valid.

With reference to FIG. 7, an illustration of a block diagram of rules is depicted in accordance with an illustrative embodiment. In this illustration, an example of a number of components of rules 406 in metadata 220 for web page 318 is shown.

In this illustrative example, rules 406 include service interactions 702, bindings 704, and compound validations 706. Service interactions 702 are code that perform actions based on user input provided to objects 504 specified in layout 404 in metadata 220 for web page 318.

For example, service interactions 702 for objects 504 may include program code for generating an order form based on user input made to objects 504. In this example, the program code for generating the order form in service interactions 702 is executed when user input made to objects 504 on web page 318 is received. For example, the order form may be a JSON object that is generated by service interactions 702.

As another example, service interactions 702 for objects 504 may include program code for calculating a value for an object in objects 504 based on user input provided to objects 504. In this example, the program code for calculating the value in service interactions 702 is executed when user input to objects 504 on web page 318 is received. For example, the value may be the output of an algorithm implemented by service interactions 702 for web page 318 that processes user input made to objects 504.

Bindings 704 are code that links user input and content in objects 504 to an application programming interface for sending and retrieving user input and content. For example, a binding in bindings 704 for a text box in web page 318 may include code that sends the text entered into the text box as a JSON object using a restful application programming interface.

Compound validations 706 are codes that validate a group of objects 504. For example, when web page 318 includes a group of name and address text boxes, a compound validation for the group of name and address text boxes may include code that validates the name and address entered.

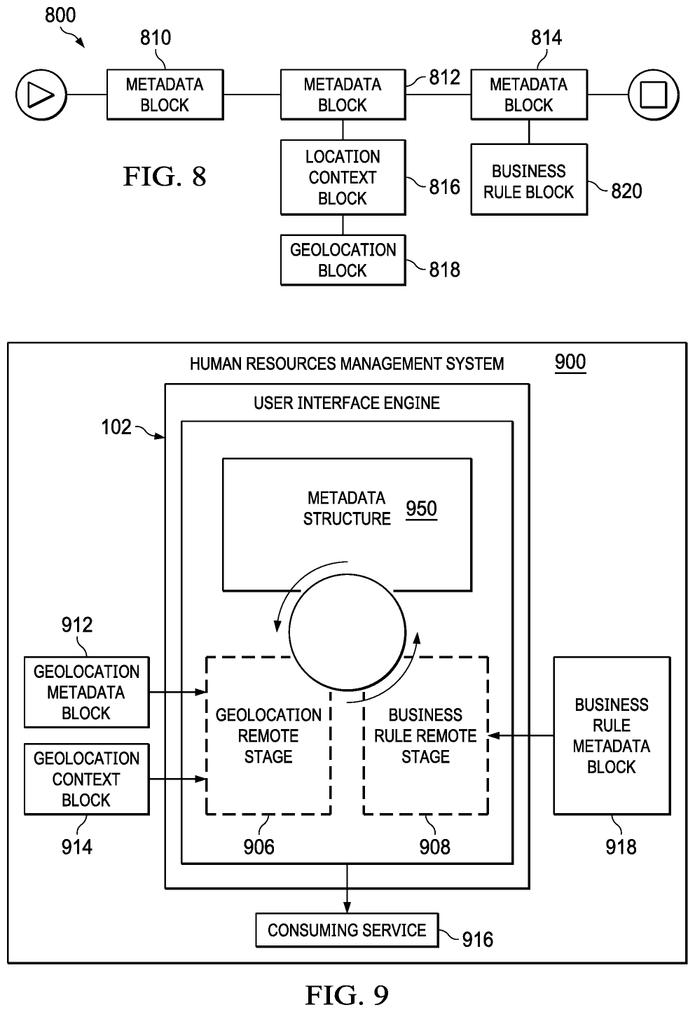

With reference next to FIG. 8, an illustration of a block diagram of a metadata tree structure is depicted in accordance with an illustrative embodiment. Metadata tree structure 800 is an example of metadata 220, shown in block form in FIG. 2.

Metadata tree structure 800 includes metadata blocks 810, 812, and 814. Metadata blocks 810, 812, and 814 are metadata objects that can be manipulated within data and metadata binding module 106 of FIG. 1 to create desired business rules. Each of metadata blocks 810, 812, and 814 correlate to one or more executor functions, which in turn can be interpreted by business rule and workflow module 108 of FIG. 1 for implementing the corresponding business rule. These functions all operate inside of a context defined at the beginning of the business rule execution step which is the target object for all symbols defined in the course of the business rule execution, as well as for all input to and output from the business rule itself. The different permutations of the compositions of these functions, as well as differentiated input, are what enable the execution of the different business rule behaviors at runtime.

Metadata tree structure 800 further includes location context block 816. Location context block 816 is an example of metadata blocks 336 indicated by location context tile 340 of FIG. 3. Location context block 816 provides additional context for execution of related metadata block 812. Specifically, location context block 816 may indicate that metadata block 8912, as well as child metadata blocks thereof, should be interpreted within an indicated location context, such as a location context determined from user information 344, shown in block form in FIG. 3.

Metadata tree structure 800 further includes geolocation block 818. Geolocation block 818 is an example of metadata blocks 336 indicated by geolocation tile 338 of FIG. 3. Geolocation block 818 provides additional context for execution of related metadata block 812 and location context block 816. Specifically, geolocation block 818 may indicate that information required for execution of mobile metadata block 812 should be requested and received from one or more geolocation services, such as geolocation services 342 of FIG. 3. Geolocation block 818 requests and returns the same context updated with the information received through the geolocation services.

Metadata mobile structure 800 further includes business rule block 820. Business rule block 820 provides additional context for execution of related metadata block 814. Specifically, business rule block 820 may indicate a consuming service for receipt of business rule output provided by related metadata block 814. Business rule block 820 requests and returns information to a consuming service, such as web page 318 in FIG. 3.

FIG. 9 is an illustration of a block diagram of an architecture of a metadata-based human resources management system depicted in accordance with an illustrative embodiment. Human resources management system 900 is an example of information system 302, and is presented as a network-based business system including both server computers and client computers.

Human resources management system 900 includes user interface engine 102. User interface engine 102 is a server-side or node computer where the interpreter fetches metadata. It is not necessarily a restful request, but may be any methodology used to provision the metadata used by the business rule interpreter, which is the primary function of geolocation remote stage 906 and business rule remote stage 908.

User interface engine 102 provides one or more context object identifications to geolocation remote stage 906 and business rule remote stage 908, which may be implemented in a server-side computer, such as in user interface engine orchestrator 118 of remote server computer 116 of FIG. 1. The identifications are the identifications against which metadata documents can be resolved.

User interface engine 102 may be referred to as the engine inside the application. User interface engine 102 may be a wrapper around the interpreter intended to separate the logic of metadata retrieval and resolution, not compilation, but duplicating and caching, from the actual metadata interpretation. User interface engine 102 interprets metadata blocks of metadata structure 950 and generates output therefrom.

Geolocation remote stage 906 can be implemented as part of metadata blocks 336 for geolocation tile 338 of FIG. 3. Geolocation remote stage 906 is a program that allows communication between user interface engine 102 and geolocation services 342 of FIG. 3. Geolocation remote stage 906 “exposes” some internal functions of geolocation services 342 to user interface engine 102 in a limited fashion. Geolocation remote stage 906 enables both user interface engine 102 to share data with geolocation services 342, and geolocation services 342 to take actions on behalf of user interface engine 102.

In this illustrative example, geolocation metadata block 912 and geolocation context block 914 provide additional context for execution of related metadata blocks. Geolocation metadata block 912 and geolocation context block 914 return the same context updated with the identified location context and geolocation services information.

Geolocation remote stage 906 receives interpreted metadata provided from user interface engine 102. Geolocation remote stage 906 generates output from the interpreted metadata. Output is the output provided corresponding to the metadata and input values passed into geolocation remote stage 906.

Output is already executable because they are generated from the pre-determined atomic units of code specified by the executor functions selected client-side. Output is the output provided by user interface engine 102 to geolocation remote stage 906 that corresponds to the interpreted metadata blocks of metadata structure 950 as indicated by geolocation metadata block 912.

Business rule remote stage 908 can be implemented as part of metadata for a business rule metadata block, such as business rule block 820 of FIG. 8. Business rule remote stage 908 is a program that allows communication between user interface engine 102 and consuming service 916, which can be web page 318 of FIG. 3. Business rule remote stage 908 “exposes” some internal functions of the consuming service in a limited fashion. Business rule remote stage 908 enables user interface engine 102 to share data with consuming service, and enables the consuming service to take actions on behalf of, and using data provided by user interface engine 102.

Business rule remote stage 908 receives interpreted metadata provided from user interface engine 102. Business rule remote stage 908 generates business rule output from the interpreted metadata. Business rule output is the output corresponding to the metadata and input values passed into business rule remote stage 908. Business rule remote stage 908 sends business rule output to the consuming service, enabling consuming service 916 to perform a human resources operation.

In this illustrative example, a user incorporates business rule metadata block 918 into metadata structure 950. In this manner, business rule metadata block 918 provides additional context for execution of related metadata blocks inclusive of its children, and provides business rule output to consuming service 916.

Business rule output is already executable because they are generated from the pre-determined atomic units of code specified by the executor functions selected client-side. The business rule output is the output provided by user interface engine 102 to business rule remote stage 908 that corresponds to the interpreted metadata blocks of metadata structure 950 as indicated by business rule metadata block 918.

Thus, the business rule output is provided directly to consuming service 916, which executes the output of business rule remote stage 908. By avoiding translation of metadata and compilation of executable code, the speed of both rule generation and rule execution is dramatically increased.

Consuming service 916 represents a service for performing a human resources operation. Consuming service 916 can be a service that either requested that a business rule be executed, require output there from, or combinations thereof. Consuming service 916 can be, but is not necessarily restricted to a web application for performing a human resources operation. In one illustrative example, consuming service 916 can be implemented as a web page, such as web page 318 of FIG. 3.

Human resources management system 900 is a specific implementation of the illustrative embodiments. Thus, human resources management system 900 does not necessarily limit the claimed inventions, or other business rule systems described herein.

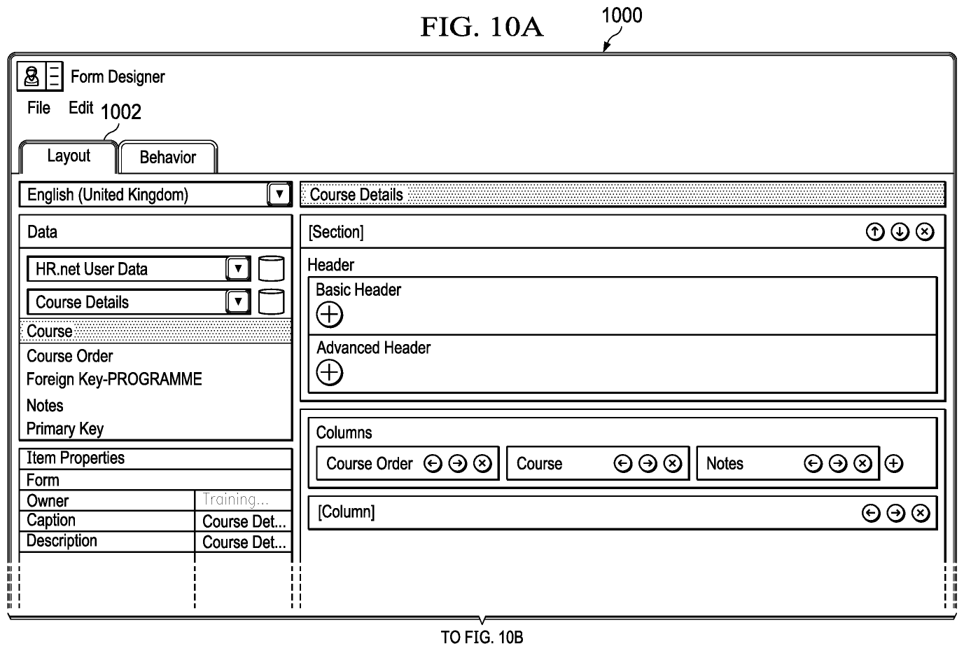

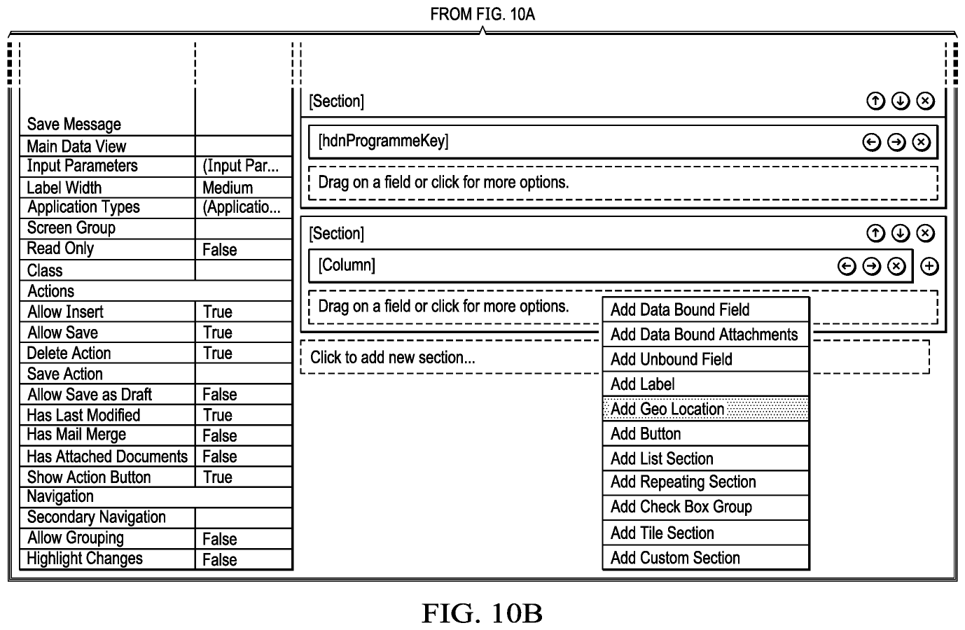

FIGS. 10-12 are diagrams of illustrative examples of a graphical user interface that may be used to design a web page. With reference first to FIGS. 10A-10B, an illustration of a graphical user interface for designing a web page is depicted in accordance with an illustrative embodiment. As depicted, graphical user interface 1000 is an example of one implementation for graphical user interface 200 shown in block form in FIG. 2.

In this illustrative example, graphical user interface 1000 includes a number of different graphical elements in a number of different sections. As depicted, graphical user interface 1000 has layout 1002.

Layout 1002 provides a description of how a group of objects are arranged relative to each other on a graphical user interface when the group of objects is displayed. For example, layout 1002 may be included in metadata 220 for web page 318, storing information for the group of objects into layout 404 in metadata 220 for web page 318.

As depicted, a user has selected to “add (a) geolocation” tile to layout 1002. The geolocation tile, which can be geolocation tile 338 of FIG. 3, corresponds to one or more metadata blocks indicating that one or more geolocation services should be invoked to implement the web page.

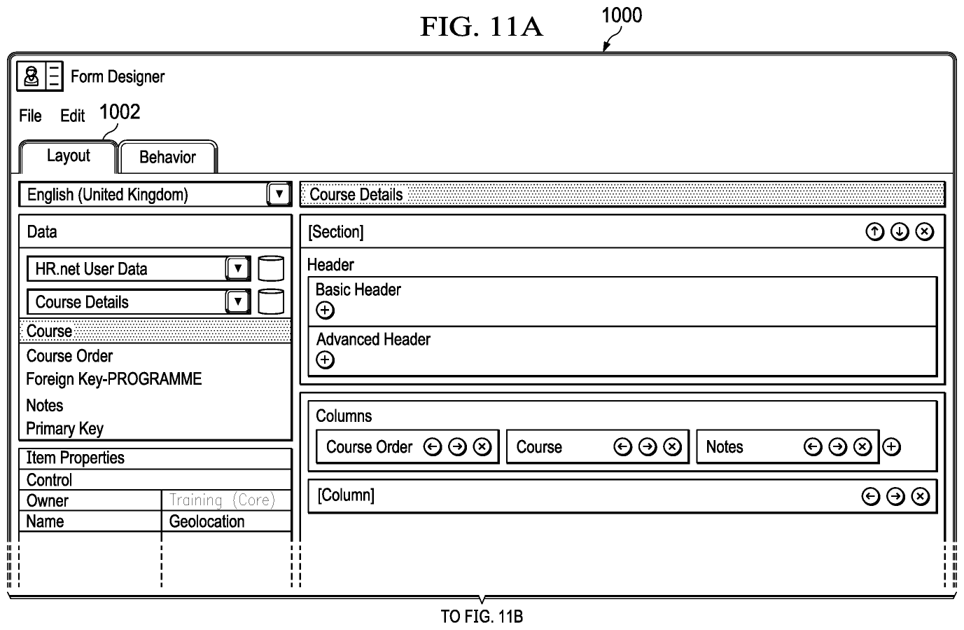

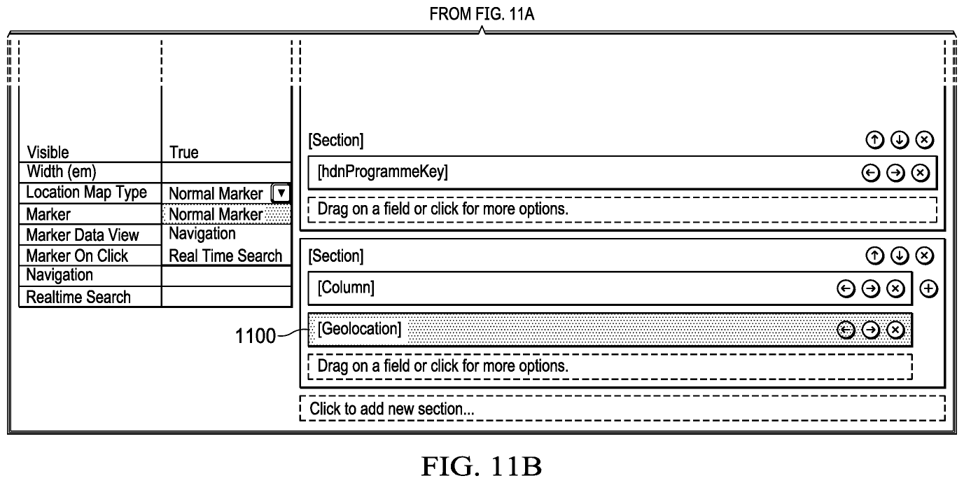

With reference next to FIGS. 11A-11B, a second illustration of a graphical user interface for designing a web page is depicted in accordance with an illustrative embodiment. As depicted, geolocation object 1100 is added to layout 1002 of graphical user interface 1000.

As illustrated, a user can select properties, such as attributes 604 of FIG. 6, when geolocation object 1100 is added to layout 1002. The control allows different types of geolocation features to be added to a web page by requesting and receiving different information from the referenced geolocation service.

A selection of “Normal Marker” is used to mark points based on location fields available in a human capital management system, which can be fields in user information 344 of FIG. 3. A selection of “Navigation” is used to manage navigation between two different location fields available in the human capital management system. A selection of “Real Time Search” is used to perform a real time search in the surroundings of a location field available in the human capital management system.

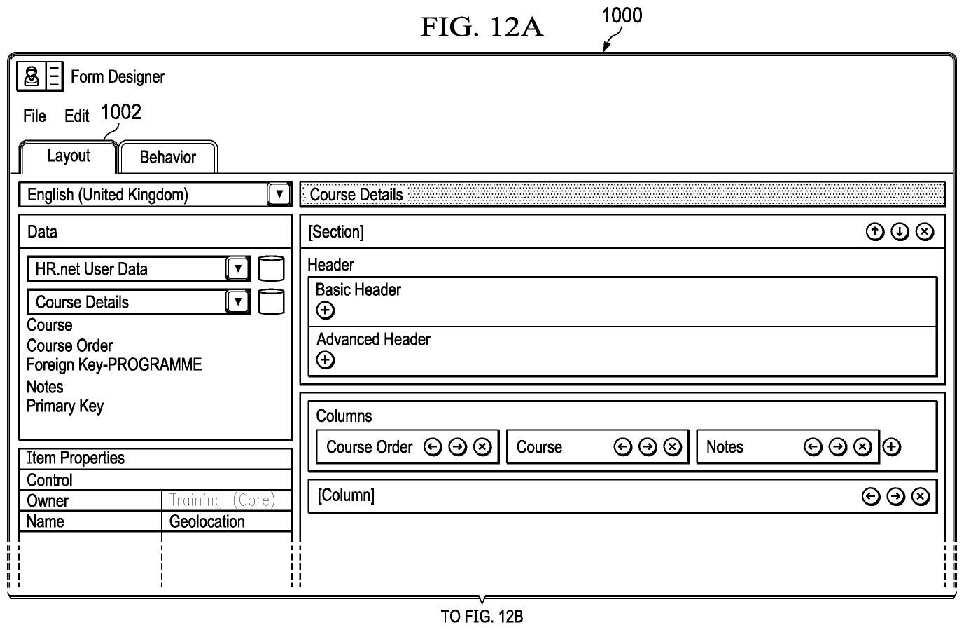

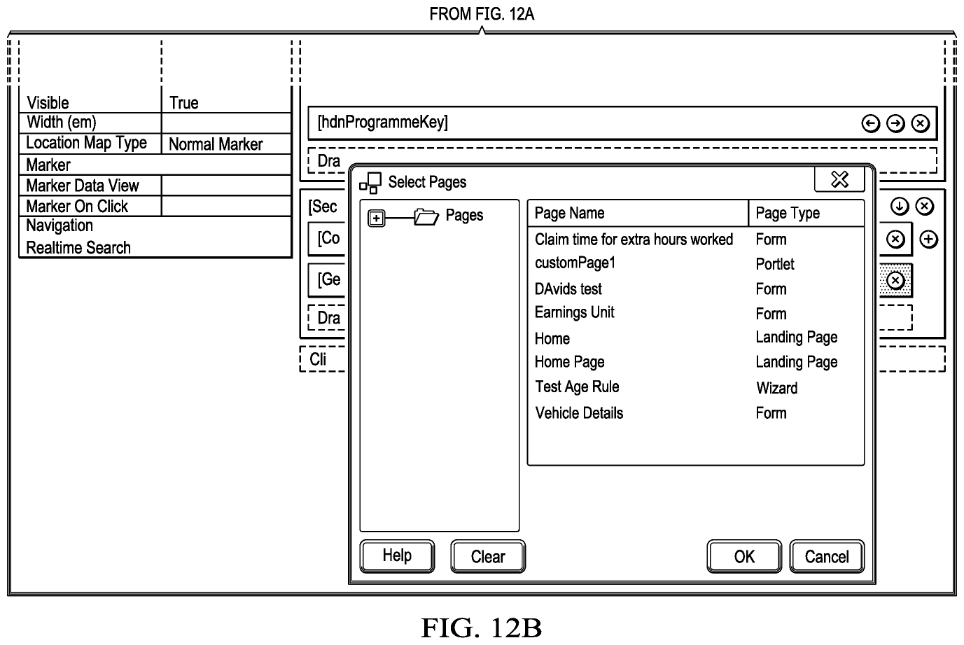

With reference next to FIGS. 12A-12B, a third illustration of a graphical user interface for designing a web page is depicted in accordance with an illustrative embodiment. As depicted, geolocation object 1100 is added to layout 1002 of graphical user interface 1000.

As illustrated, a user can select rules, such as attributes 604 of FIG. 6, when geolocation object 1100 is added to layout 1002. The user can select rules, which are then saved as metadata. For example, a selection of the “Normal Marker” property may trigger a filter panel to be available. The markers displayed in the web page are filtered based on the data in the dataview. Similarly, an “On Click” service interaction for the marker links geolocation object 1100 to another page within the system using metadata.

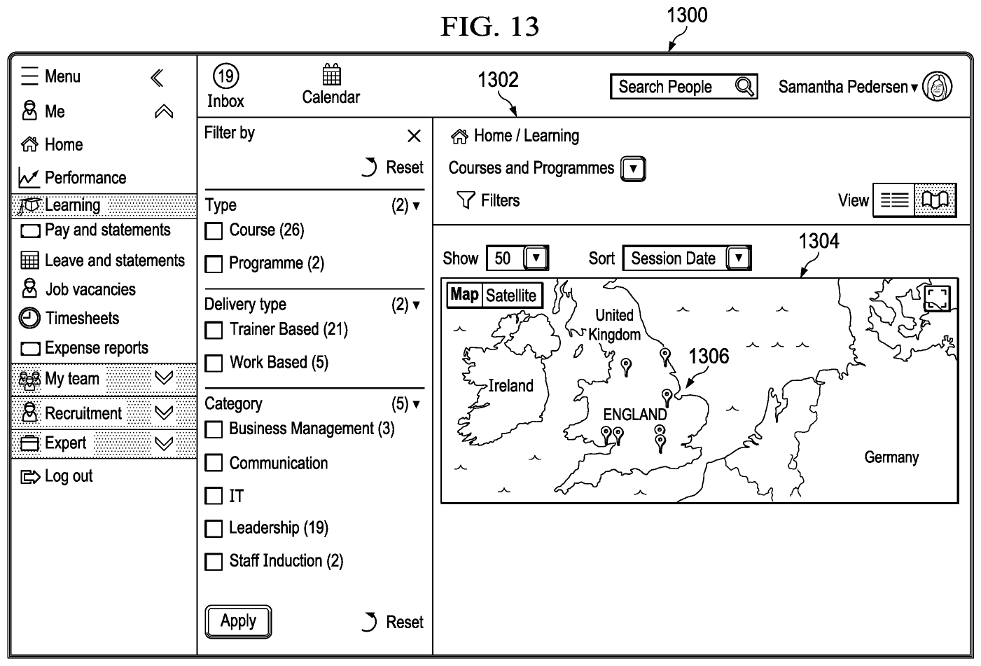

FIGS. 13-17 are illustrations of a graphical user interface that may be used to design a web page. With reference first to FIG. 13, an illustration of a web page that displays geolocation objects is depicted in accordance with an illustrative embodiment. As depicted, graphical user interface 1300 is an example of one implementation for graphical user interface 200 shown in block form in FIG. 2.

As depicted, graphical user interface 1300 displays web page 1302. Web page 1302 includes map 1304. Map 1304 displays geolocation objects 1306. Geolocation objects 1306 are displayed in map 1304 when a geolocation block, such as geolocation block 818 of FIG. 8, is incorporated into a metadata tree structure describing web page 1302, as shown in FIGS. 10-12.

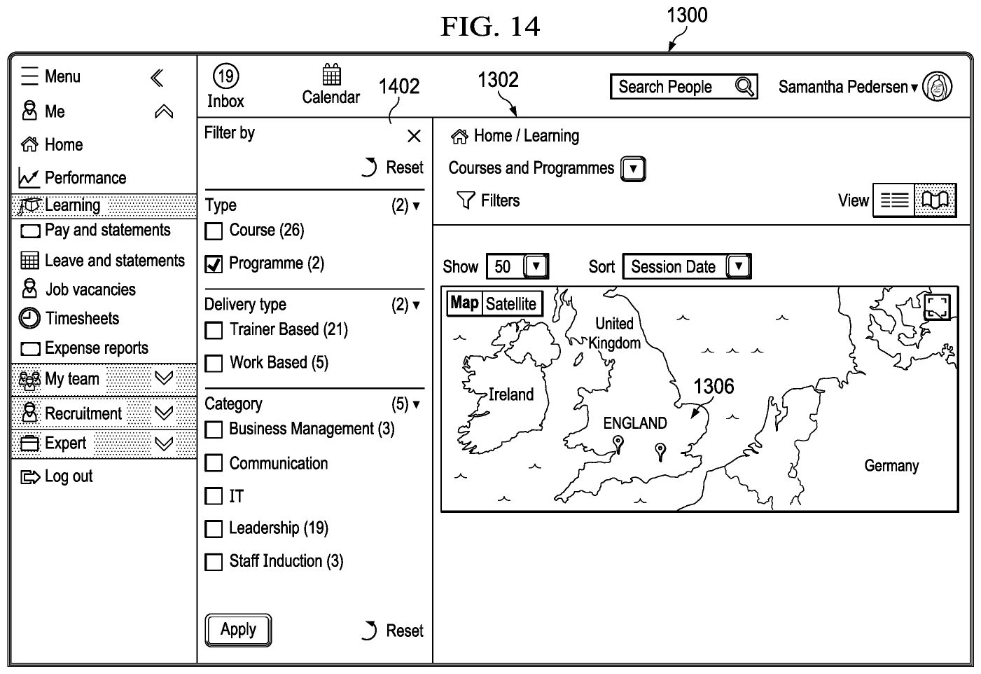

With reference next to FIG. 14, an illustration of a web page that displays filtered geolocation features is depicted in accordance with an illustrative embodiment.

As depicted, graphical user interface 1300 includes filter panel 1402. Web page 1302 displays filter panel 1402 according to rules, saved as metadata, for geolocation objects 1306. In this illustrative example, a selection of the “Normal Marker” property for geolocation objects 1306, as shown in FIGS. 12A-12B, may trigger web page 1300 to display filter panel 1402. Geolocation objects 1306 displayed in web page 1300 are filtered based on the selected data in the dataview.

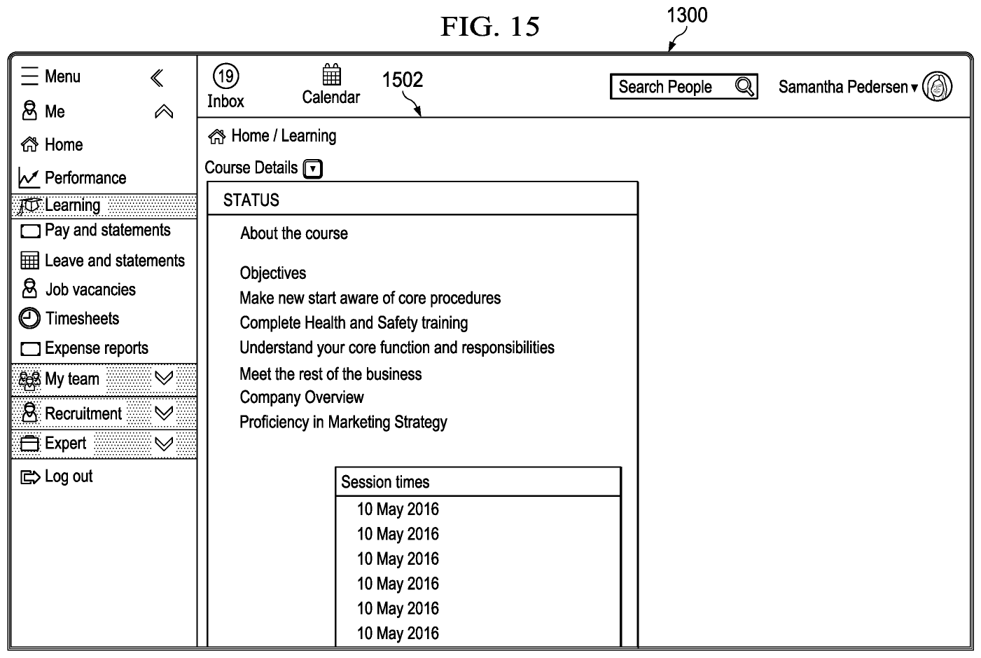

With reference next to FIG. 15, an illustration of a second web page that displays information for a selected filtered geolocation object is depicted in accordance with an illustrative embodiment.

As depicted, graphical user interface 1300 displays web page 1502. Graphical user interface 1300 displays web page 1502 in response to a selection of an associated one of geolocation objects 1306. In this illustrative example, a selection of an “On Click” service interaction for geolocation objects 1306, as shown in FIGS. 12A-12B, links the associated one of geolocation objects 1306 to web page 1502 using page metadata.

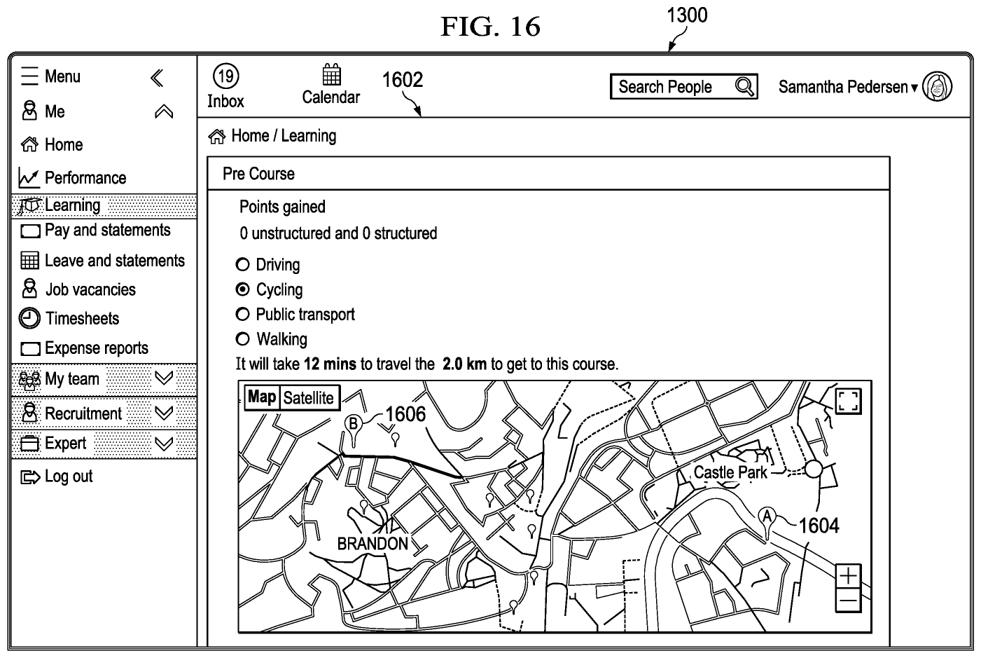

With reference next to FIG. 16, an illustration of a third web page that displays information for a selected filtered geolocation object is depicted in accordance with an illustrative embodiment.

As depicted, graphical user interface 1300 displays web page 1602. In this illustrative example, web page 1602 displays a navigation route between geolocation objects 1604 and 1606. In this illustrative example, a selection of the “Navigation” property for geolocation objects 1604 and 1606, as shown in FIGS. 12A-12B, may trigger web page 1602 to manage navigation between the two different locations of geolocation objects 1604 and 1606.

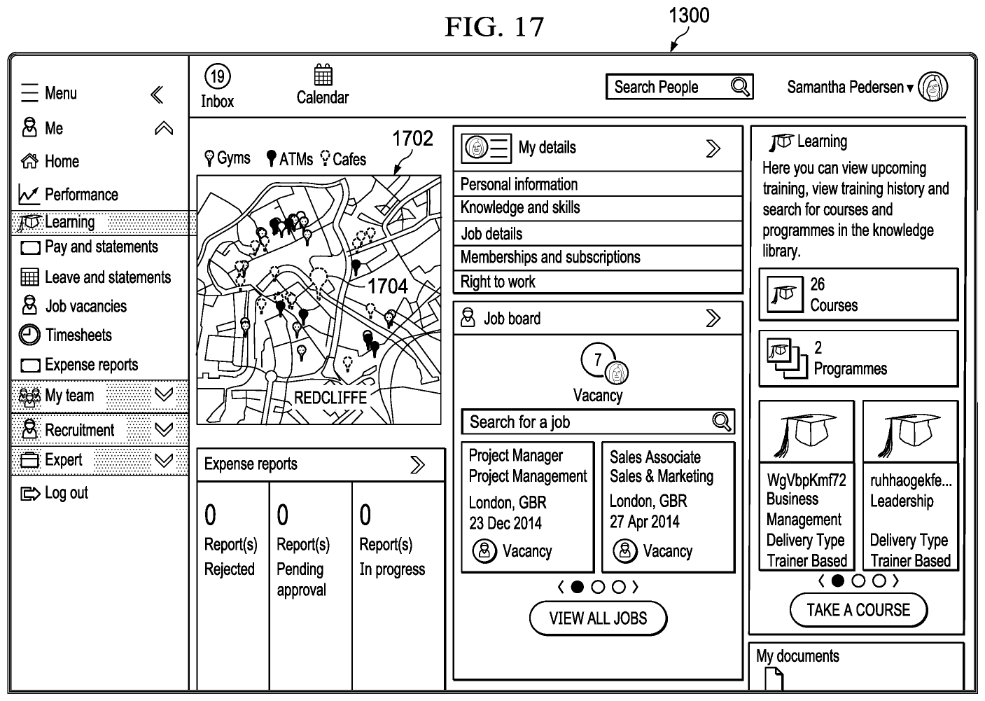

With reference next to FIG. 17, an illustration of a fourth web page that displays information for a selected filtered geolocation object is depicted in accordance with an illustrative embodiment.

As depicted, graphical user interface 1300 displays web page 1702. In this illustrative example, web page 1702 displays a real time search in the surroundings of a location field available in a human capital management system. In this illustrative example, a selection of the “Realtime” property for geolocation object 1704, as shown in FIGS. 12A-12B, may trigger web page 1702 to display other geolocation objects based on a real time search in the areas surrounding geolocation object 1704.

Thus, the illustrative examples provide a method and apparatus for designing web pages. In one illustrative example, a method and apparatus provide one or more technical solutions that overcome the technical problem of the knowledge and experience about web page servers needed to design web pages. In the technical solution, the process implemented in a web page designer using metadata has a technical effect that avoids an operator needing knowledge and experience about a web page server.

Thus, an operator may focus on designing the web page and does not need to access or have knowledge or experience about the web page server. The operator may focus on designing a particular look, feel, function, or other goal for the web page.

The illustrative example also solves the technical problem of having sufficient resources for web page servers to generate web pages. In the illustrative example, a technical solution is present in which client data processing systems generate web pages using metadata, causing a technical effect by reducing resources that are needed for a web page server. For example, the web page server may only send metadata and does not need to use resources to generate the web page. As a result, web pages may be displayed more quickly on client data processing systems even when high levels of traffic are present on the web page server.

In contrast, current web page servers process the markup language for a web page and find the content for the web page. The current web page servers then send the web page and the content to a browser on the client data processing system to display.

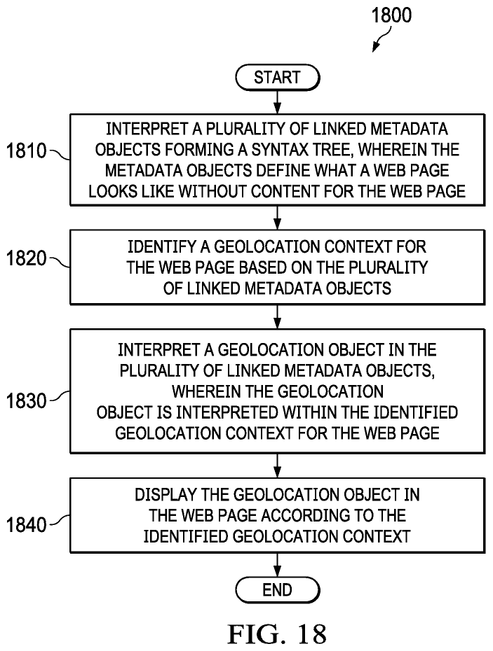

With reference next to FIG. 18, a flowchart of a process for digitally performing a human resources operation is depicted in accordance with an illustrative embodiment. Process 1800 may be implemented in one or more of computer system 324 and client data processing system 310 of FIG. 3. For example, process 1800 may be implemented as operations performed by one or more of application development system 100 and web page generator 350, shown in block form in FIG. 3.

Process 1800 begins by interpreting a plurality of linked metadata objects forming a syntax tree (step 1810). The metadata objects defining what the web page looks like without content for the web page.

Process 1800 then identifies a geolocation context for the web page (step 1820). The geolocation context is identified based on a plurality of linked metadata objects.

Process 1800 then interprets a geolocation object in the plurality of linked metadata objects (step 1830). The geolocation object is interpreted within the identified geolocation context for the web page.

Process 1800 then displays the geolocation object in the web page according to the identified geolocation context (step 1840), with process 1800 terminating thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

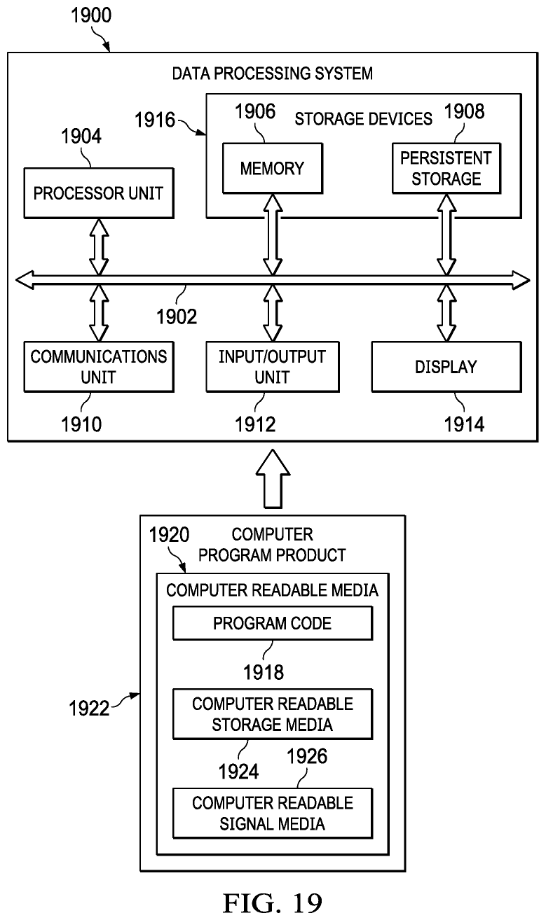

Turning now to FIG. 19, an illustration of a block diagram of a data processing system is depicted in accordance with an illustrative embodiment. Data processing system 1900 may be used to implement one or more computers and computer system 122 in FIG. 1. In this illustrative example, data processing system 1900 includes communications framework 1902, which provides communications between processor unit 1904, memory 1914, persistent storage 1916, communications unit 1908, input/output unit 1910, and display 1912. In this example, communications framework 1902 may take the form of a bus system.

Processor unit 1904 serves to execute instructions for software that may be loaded into memory 1914. Processor unit 1904 may be a number of processors, a multi-processor core, or some other type of processor, depending on the particular implementation.

Memory 1914 and persistent storage 1916 are examples of storage devices 1906. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1906 may also be referred to as computer-readable storage devices in these illustrative examples. Memory 1914, in these examples, may be, for example, a random access memory or any other suitable volatile or non-volatile storage device. Persistent storage 1916 may take various forms, depending on the particular implementation.

For example, persistent storage 1916 may contain one or more components or devices. For example, persistent storage 1916 may be a hard drive, a flash memory, a rewritable optical disk, a rewritable magnetic tape, or some combination of the above. The media used by persistent storage 1916 also may be removable. For example, a removable hard drive may be used for persistent storage 1916.

Communications unit 1908, in these illustrative examples, provides for communications with other data processing systems or devices. In these illustrative examples, communications unit 1908 is a network interface card.

Input/output unit 1910 allows for input and output of data with other devices that may be connected to data processing system 1900. For example, input/output unit 1910 may provide a connection for user input through at least of a keyboard, a mouse, or some other suitable input device. Further, input/output unit 1910 may send output to a printer. Display 1912 provides a mechanism to display information to a user.

Instructions for at least one of the operating system, applications, or programs may be located in storage devices 1906, which are in communication with processor unit 1904 through communications framework 1902. The processes of the different embodiments may be performed by processor unit 1904 using computer-implemented instructions, which may be located in a memory, such as memory 1914.

These instructions are referred to as program code, computer-usable program code, or computer-readable program code that may be read and executed by a processor in processor unit 1904. The program code in the different embodiments may be embodied on different physical or computer-readable storage media, such as memory 1914 or persistent storage 1916.

Program code 1918 is located in a functional form on computer-readable media 1920 that is selectively removable and may be loaded onto or transferred to data processing system 1900 for execution by processor unit 1904. Program code 1918 and computer-readable media 1920 form computer program product 1922 in these illustrative examples. In one example, computer-readable media 920 may be computer-readable storage media 1924 or computer-readable signal media 1926.

In these illustrative examples, computer-readable storage media 1924 is a physical or tangible storage device used to store program code 1918 rather than a medium that propagates or transmits program code 1918. Alternatively, program code 1918 may be transferred to data processing system 1900 using computer-readable signal media 1926.

Computer-readable signal media 1926 may be, for example, a propagated data signal containing program code 1918. For example, computer-readable signal media 1926 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1900 are not meant to provide architectural limitations to the manner in which different embodiments may be implemented. The different illustrative embodiments may be implemented in a data processing system including components in addition to or in place of those illustrated for data processing system 1900. Other components shown in FIG. 19 can be varied from the illustrative examples shown. The different embodiments may be implemented using any hardware device or system capable of running program code 1918.

Thus, the illustrative examples provide a method and apparatus for designing web pages. In one illustrative example, a method and apparatus overcome the technical problem of the knowledge and experience about web page servers needed to design web pages.

In another illustrative example, a method and apparatus overcome the technical problem of designing web pages for display on different types of browsers. In the technical solution, the process using the metadata has a technical effect that avoids an operator needing knowledge and experience about a web page server. Additionally, the technical solution provided by this process has a technical effect of reducing the need for the operator viewing a web page on different types of browsers to see whether the web page has a desired display on those browsers.

Thus, the operator designing a web page may focus on designing the web page rather than identifying differences in the manner in which the web page may be displayed on different browsers. In this manner, the operator designing a web page may focus on how the web page should look rather than having to worry about how the web page will be displayed on different browsers or having knowledge about web servers to view or test web pages. Thus, the operator may focus on designing the web page for a particular look, feel, function, or other goal.

Further, when web pages are displayed on a browser on a client data processing system, the display of the web pages may occur more quickly, with less use of web page server resources, more consistently, or some combination thereof. For example, a client data processing system may display web pages more quickly because the web pages are generated on the client data processing system instead of on a web server on a remote computer. In particular, displaying web pages using metadata and content on a client data processing system overcomes the technical problem of having sufficient resources for web page servers to generate web pages. As a result, a technical effect occurs in which web pages are displayed more quickly on client data processing systems.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for digitally performing a human resources operation, the method comprising:
interpreting, by a computer system, a plurality of linked metadata objects forming a syntax tree, wherein the metadata objects define what the web page looks like without content for the web page;
identifying, by the computer system, a geolocation context for the web page based on the plurality of linked metadata objects;
interpreting, by the computer system, a geolocation object in the plurality of linked metadata objects, wherein the geolocation object is interpreted within the identified geolocation context for the web page; and
displaying, by the computer system, the geolocation object in the web page according to the identified geolocation context.

2. The method of claim 1, further comprising:
identifying, by the computer system, a business rule corresponding to the human resources operation, wherein the business rule is identified within a plurality of linked metadata objects;
interpreting, by the computer system, the plurality of metadata objects to implement the business rule within the geolocation context; and
performing, by the computer system, the human resources operation according to the business rule.

3. The method of claim 2, wherein the business rule is implemented inside of the geolocation context determined from human resources information for an employee of an organization and defined at a beginning of an interpretation step for the first plurality of metadata objects, wherein the geolocation context is a target object for all symbols defined in a course of implementing the business rule, as well as for all input to and output from the business rule.

4. The method of claim 3, wherein interpreting the plurality of metadata objects further comprises:
entering the syntax tree and the requested input into an abstract syntax tree interpreter, wherein a compiler operation to generate computer code for implementing the business rule is avoided, and wherein executing the abstract syntax tree interpreter produces a result without using executable code to achieve the result.

5. The method of claim 2, wherein interpreting the plurality of metadata objects further comprises:
generating an output for the business rule within the geolocation context; and
wherein performing the human resources operation further comprises:
providing the output to a consuming service for performing the human resources operation according to the business rule within the geolocation context.

6. The method of claim 2, further comprising:
parsing, by the computer system, the first plurality of metadata objects within the mobile context; and
dynamically generating, by the computer system, the syntax tree from the first plurality of metadata objects.

7. The method of claim 2, further comprising:
obtaining, by the computer system, the content for the web page according to the geolocation context; and
creating, by the client data processing system, the web page using the metadata and the content within the geolocation context.

8. The method of claim 2, wherein interpreting the geolocation object further comprises:
identifying rules and properties for the geolocation object, wherein the rules and properties are indicated within the plurality of linked metadata objects; and
displaying, by the computer system, the geolocation object in the web page according to the rules and properties indicated within the plurality of linked metadata objects.

9. A computer system comprising:
a hardware processor; and
a web page generator in communication with the hardware processor, wherein the web page generator is configured:
to interpret a plurality of linked metadata objects forming a syntax tree, wherein the metadata objects define what the web page looks like without content for the web page;
to identify a geolocation context for the web page based on the plurality of linked metadata objects;
to interpret a geolocation object in the plurality of linked metadata objects, wherein the geolocation object is interpreted within the identified geolocation context for the web page; and
to display the geolocation object in the web page according to the identified geolocation context.

10. The computer system of claim 9, wherein the web page generator is further configured:
to identify a business rule corresponding to the human resources operation, wherein the business rule is identified within a plurality of linked metadata objects;
to interpret the plurality of metadata objects to implement the business rule within the geolocation context; and
to perform the human resources operation according to the business rule.

11. The computer system of claim 10, wherein the business rule is implemented inside of the geolocation context determined from human resources information for an employee of an organization and defined at a beginning of an interpretation step for the first plurality of metadata objects, wherein the geolocation context is a target object for all symbols defined in a course of implementing the business rule, as well as for all input to and output from the business rule.

12. The computer system of claim 11, wherein in interpreting the plurality of metadata objects, the web page generator is further configured:
to enter the syntax tree and the requested input into an abstract syntax tree interpreter, wherein a compiler operation to generate computer code for implementing the business rule is avoided, and wherein executing the abstract syntax tree interpreter produces a result without using executable code to achieve the result.

13. The computer system of claim 10, wherein in interpreting the plurality of metadata objects, the web page generator is further configured:
to generate an output for the business rule within the geolocation context; and
wherein performing the human resources operation further comprises:
providing the output to a consuming service for performing the human resources operation according to the business rule within the geolocation context.

14. The computer system of claim 10, wherein the web page generator is further configured:
to parse the plurality of metadata objects within the geolocation context; and
to dynamically generate the syntax tree from the plurality of metadata objects.

15. The computer system of claim 10, wherein the web page generator is further configured:
to obtain the content for the web page according to the geolocation context; and
to create the web page using the metadata and the content within the geolocation context.

16. The computer system of claim 10, wherein in interpreting the geolocation object, the web page generator is further configured:
to identify rules and properties for the geolocation object, wherein the rules and properties are indicated within the plurality of linked metadata objects; and
to display the geolocation object in the web page according to the rules and properties indicated within the plurality of linked metadata objects.

17. A computer program product for digitally performing a human resources operation, the computer program product comprising:
a non-transitory computer readable storage media;
program code, stored on the computer readable storage media, for interpreting, by a computer system, a plurality of linked metadata objects forming a syntax tree, wherein the metadata objects define what the web page looks like without content for the web page;
program code, stored on the computer readable storage media, for identifying a geolocation context for the web page based on the plurality of linked metadata objects;
program code, stored on the computer readable storage media, for interpreting a geolocation object in the plurality of linked metadata objects, wherein the geolocation object is interpreted within the identified geolocation context for the web page; and
program code, stored on the computer readable storage media, for displaying the geolocation object in the web page according to the identified geolocation context.

18. The computer program product of claim 17, further comprising:
program code, stored on the computer readable storage media, for identifying a business rule corresponding to the human resources operation, wherein the business rule is identified within a plurality of linked metadata objects;
program code, stored on the computer readable storage media, for interpreting the plurality of metadata objects to implement the business rule within the geolocation context; and
program code, stored on the computer readable storage media, for performing the human resources operation according to the business rule.

19. The computer program product of claim 18, wherein the business rule is implemented inside of the geolocation context determined from human resources information for an employee of an organization and defined at a beginning of an interpretation step for the first plurality of metadata objects, wherein the geolocation context is a target object for all symbols defined in a course of implementing the business rule, as well as for all input to and output from the business rule.

20. The computer program product of claim 18, wherein the code for interpreting the plurality of metadata objects further comprises:
program code, stored on the computer readable storage media, for entering the syntax tree and the requested input into an abstract syntax tree interpreter, wherein a compiler operation to generate computer code for implementing the business rule is avoided, and wherein executing the abstract syntax tree interpreter produces a result without using executable code to achieve the result.

21. The computer program product of claim 18, wherein the code for interpreting the plurality of metadata objects further comprises:
program code, stored on the computer readable storage media, for generating an output for the business rule within the geolocation context; and
wherein the code for performing the human resources operation further comprises:
program code, stored on the computer readable storage media, for providing the output to a consuming service for performing the human resources operation according to the business rule within the geolocation context.

22. The computer program product of claim 18, further comprising:
parsing, by the computer system, the first plurality of metadata objects within the mobile context; and
dynamically generating, by the computer system, the syntax tree from the first plurality of metadata objects.

23. The computer program product of claim 18, further comprising:
program code, stored on the computer readable storage media, for obtaining the content for the web page according to the geolocation context; and
program code, stored on the computer readable storage media, for creating the web page using the metadata and the content within the geolocation context.

24. The computer program product of claim 18, wherein the code for interpreting the geolocation object further comprises:
program code, stored on the computer readable storage media, for identifying rules and properties for the geolocation object, wherein the rules and properties are indicated within the plurality of linked metadata objects; and
program code, stored on the computer readable storage media, for displaying the geolocation object in the web page according to the rules and properties indicated within the plurality of linked metadata objects.
